(19) United States
(12) Patent Application Publication
(10) Pub. No.: US 2010/0270437 A1
(43) Pub. Date: Oct. 28, 2010

(54) Mouse mate

(76) Inventor: James D' Aguisto, II, Centereach, NY (US)

Correspondence Address: Allan Chan, Suite 700, 225 Broadway, New York, NY, 10007, US

(21) Appl. No.: 12/386,874

(22) Filed: Apr. 24, 2009

(51) Int. Cl. F16L 3/02; A44B 21/00; A44B 18/00

(52) U.S. Cl. 248/51; 24/457; 24/442

(57) ABSTRACT

A mouse cord stand or stand for supporting a mouse cord includes a mechanism to attach the cord on a vertical member having the opposite end attached to a base. The vertical member may be telescopically extended to the maximum comfort level of the user or for maximum dis-entanglement of said mouse cord.

A base is attached to the vertical member. Said base my be molded for maximum stability based upon weight or configuration. Alternatively, said base may further utilize adhesives or screws.

### BACKGROUND OF THE INVENTION

The invention relates to structures on or in which a mouse cord may be placed for support and, more particularly, to be keep loose and facilitate movement.

Currently, mouse cords are left alone to be entangled with other objects and restrict the full movement of a mouse.

### SUMMARY OF THE INVENTION

A mouse cord stand or stand for supporting a mouse cord includes a mechanism to attach the cord on a vertical member having the opposite end attached to a base. The vertical member may be telescopically extended to the maximum comfort level of the user or for maximum dis-entanglement of said mouse cord.

A base is attached to the vertical member. Said base my be molded for maximum stability based upon weight or configuration. Alternatively, said base may further utilize adhesives or screws.

### BRIEF DESCRIPTION OF THE DRAWINGS

While the specification concludes with claims particularly pointing out and distinctly claiming the subject matter of the invention, it is believed the invention will be better understood from the following description, taken in conjunction with the accompanying drawings, wherein:

FIG. 1 is a top view of a stand for attaching a mouse cord;

FIG. 2 is a view illustrating the base of the stand;

FIG. 3 is a view illustrating the cord attached to the clip;

FIG. 4 is a perspective view of the mousemate;

FIG. 5 is a partial cross-sectional view of the internal components in a compressed position of the pins;

### DESCRIPTION OF THE PREFERRED EMBODIMENT

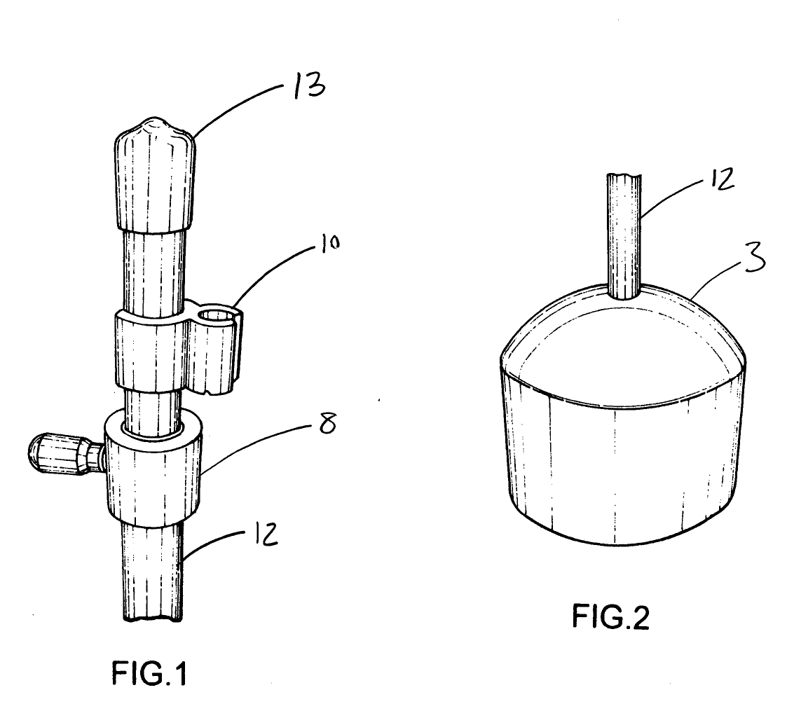

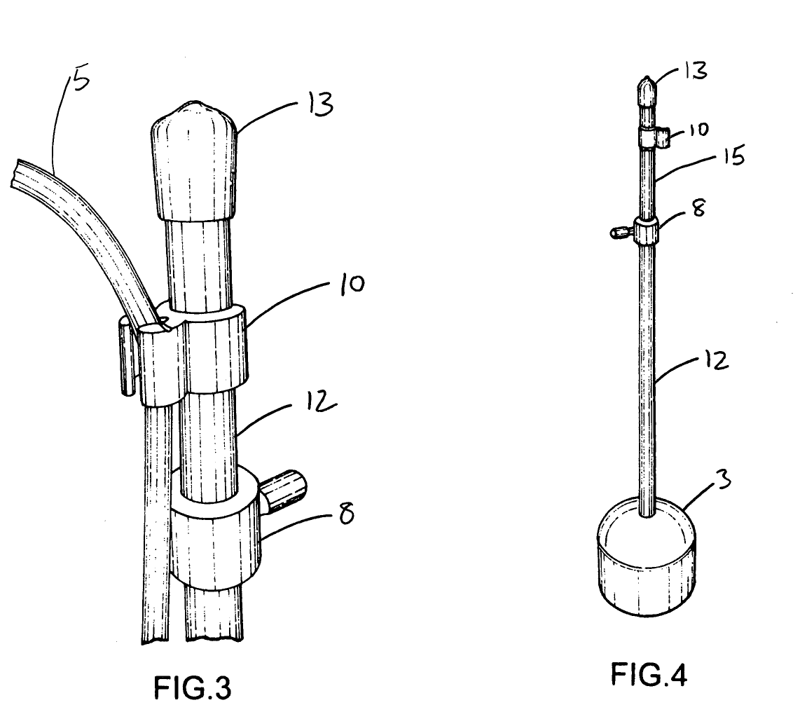

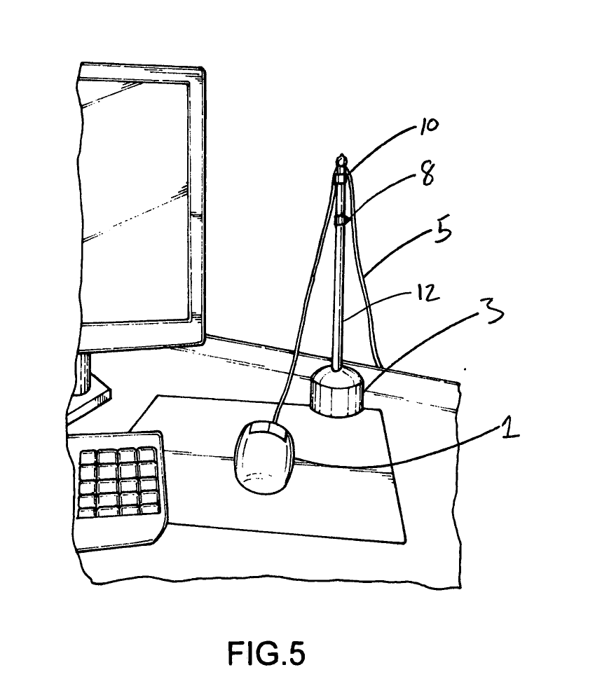

The invention described herein provides an apparatus for supporting a mouse cord 5 of a mouse 1 at various heights. Referring to FIGS. 1-5, a mouse mate stand may be used for supporting an mouse cord 5, or any other device such as a webcam. The stand is adjustable for altering the position of the mouse cord 5 with respect to the height of the stand.

The stand includes may include first vertical member 12 and a second vertical member 15 which are telescopically attached together. The mouse cord 5 is secured to the first member 12, for example by a bracket 10. The second member 15 is secured to a base 3, which rests on a surface. The first and second member 12 and 15 may be elongated cylindrical shafts, may be hollow, solid, or combinations thereof, may be any geometric shape, but still mateable with one another, or may be any other suitable type of members. An alternative embodiment, the vertical members 12 and 15 maybe hinged or have a ball and socket connection to allow for rotational movements.

Said bracket maybe any attachment mechanism commonly known to persons skilled in the art. Alternatively, a loop or ring can be used to secure the mouse cord 5. In such an embodiment, said cord 5 may be inserted into the center of the ring or loop through an opening. In a further embodiment, said attachment mechanism may be a strip of Velcro attached to the vertical member 15. Said cord 5 may be wrapped with said Velcro to secure said cord 5 to the vertical member 15.

Alternatively, said mouse mate may contain only one vertical member 12 without the telescopic feature. Said member 12 can be composed of a semi rigid polymer material to allow for flexing. Said flexibility is ideal to facilitate the ease of movement of the mouse 1. In said embodiment, said mouse mate may flex while in use and return to its original shape once use has ceased.

The stand further includes a release mechanism 8 for holding the first and second member 12 and 15 is a desired position and upon activation for allowing the first and second supports 12 and 15 to telescopically move with respect to one another. The release mechanism maybe a screw insert into the first member 12 and coupled to the second member 15. The positioning of the vertical member s 12 and 15 are secured when the screw is tightened creating enough fraction with vertical member 15. Alternatively, any release mechanism 8 commonly known to persons skilled in the art maybe used.

Said base 3 maybe weighted to increase stability of the mouse mate. Alternatively, said base maybe flat to reduce its footprint size on a user's desk. Said flat configuration of said base may include an oversized circumference to ensure stability.

Additionally, said base 3 maybe adhered to a surface. Any methods of adhesion commonly known to persons skilled in the arts maybe utilized such as but not limited to glues, Velcro, suction, magnetism, or screws. Said surfaces including but not limited to desks, tables, computer monitors, laptops, desktops, external hard drives, and/or keyboards.

Alternatively, electronics maybe incorporated into the base 3. A microphone for sensing external sound such as hand clapping, a voice of mankind or the like. Alternatively, a motion sensor may be used instead or in conjunction with said microphone to activate the switching circuit. An amplifier circuit is provided which amplifies an electric signal of the external sound. A switching circuit is operative in response to the amplified electric signal to drive the motor, LEDs, or speakers. The microphone, the amplifier circuit and the switching circuit are interlocked with each other.

Specifically, the amplifier circuit comprises four resistors and a capacitor, an electrolytic capacitor, and an transistor. The amplifier circuit has an input terminal which is connected to an output terminal of the microphone. The switching circuit may comprises five resistors, a pair of transistors, a transistor, and an electrolytic capacitor. The switching circuit has an input terminal which is connected to an output terminal of the amplifier circuit through a capacity. The transistor of the switching circuit has a collector to which the motor arranged within the container is connected. A decoupling capacitor for the entire sound-sensing operational mechanism and at least one dry cell arranged at a lower surface of a bottom plate of the base 3 are connected to an emitter of the transistor and the output terminal of the motor, LED, or microphone in parallel relation thereto. A power-source switch maybe mounted to the upper surface of the closure of the base 3.

Additionally, the cap 13 maybe shaped into an aesthetic form such as but not limited to cartoon characters, flowers, smiley face or moving objects. Said motor may be located in said cap to facilitate movement of objects such as but not limited to arms, leaves, flowers, action figures, or hands.

While the above invention has been described with reference to certain preferred embodiments, the scope of the present invention is not limited to these embodiments. One skilled in the art may find variations of these preferred embodiments which, nevertheless, fall within, the spirit of the present invention, whose scope is defined by the claims set forth below.

I claim:

1. An apparatus to organize mouse cables comprising:
a. A vertical member with a opposing end attached to a base; and
b. Said vertical member having an attachment mechanism to secure said mouse cables.

2. An apparatus as in claim 1 wherein, said vertical member is semi rigid, enabling flexing of said vertical member when said mouse cord is tugged on by a user.

3. An apparatus as in claim 1 wherein, said vertical member is composed of two members hinged together to allow for rotational adjustment.

4. An apparatus as in claim 1 wherein, said vertical member is telescoping allowing the user to adjust the height.

5. An apparatus as in claim 1 wherein, said vertical member is curved.

6. An apparatus as in claim 1 wherein, said vertical member opposing end to said base is in the form of an aesthetic shape.

7. An apparatus as in claim 1 wherein, said base is weighted to ensure stability.

8. An apparatus as in claim 1 wherein, said base is adhered to a surface with adhesive.

9. An apparatus as in claim 1 wherein, said base is fastened to a surface with screws

10. An apparatus as in claim 1 wherein, said base is adhered to a surface with Velcro.

11. An apparatus as in claim 1 wherein, said base is adhered to a surface with suction.

12. An apparatus as in claim 1 wherein, said base is adhered to a computer monitor.

13. An apparatus as in claim 1 wherein said base or vertical member will light up.

14. An apparatus as in claim 1 wherein said base contains electronics to enable sounds or music.

15. An apparatus as in claim 1 wherein said attachment mechanism is a clip.

16. An apparatus as in claim 1 wherein said attachment mechanism is a ring.

17. An apparatus as in claim 1 wherein said attachment mechanism is a loop of Velcro.

18. An apparatus to organize mouse cables comprising:
a. A vertical member with a opposing end attached to a base; and
b. Said vertical member having an attachment mechanism to secure said mouse cables.

19. An apparatus as in claim 1 wherein, said vertical member is semi rigid, enabling flexing of said vertical member when said mouse cord is tugged on by a user.

20. An apparatus as in claim 1 wherein, said vertical member is composed of two members hinged together to allow for rotational adjustment.

21. An apparatus as in claim 1 wherein, said vertical member is telescoping allowing the user to adjust the height.

22. An apparatus as in claim 1 wherein, said vertical member is curved.

23. An apparatus as in claim 1 wherein, said vertical member opposing end to said base is in the form of an aesthetic shape.

24. An apparatus as in claim 1 wherein, said base is weighted to ensure stability.

25. An apparatus as in claim 1 wherein, said base is adhered to a surface with adhesive.

26. An apparatus as in claim 1 wherein, said base is fastened to a surface with screws

27. An apparatus as in claim 1 wherein, said base is adhered to a surface with Velcro.

28. An apparatus as in claim 1 wherein, said base is adhered to a surface with suction.

29. An apparatus as in claim 1 wherein, said base is adhered to a computer monitor.

30. An apparatus as in claim 1 wherein said base or vertical member will light up.

31. An apparatus as in claim 1 wherein said base contains electronics to enable sounds or music.

32. An apparatus as in claim 1 wherein said attachment mechanism is a clip.

33. An apparatus as in claim 1 wherein said attachment mechanism is a ring.

34. An apparatus as in claim 1 wherein, said attachment mechanism is a loop of Velcro.
